(19) United States
(12) Patent Application Publication
(10) Pub. No.: US 2010/0232016 A1
(43) Pub. Date: Sep. 16, 2010

(54) Stereoscopic Binocular System, Device and Method

(75) Inventors: Benzion Landa, Nes Ziona (IL); Yehuda Niv, Nes Ziona (IL)

Correspondence Address: MARTIN D. MOYNIHAN d/b/a PRTSI, INC., P.O. BOX 16446, ARLINGTON, VA, 22215, US

(73) Assignee: Mirage Innovations Ltd., Petach-Tikva (IL)

(21) Appl. No.: 11/991,780

(22) PCT Filed: Sep. 26, 2006
(86) PCT No.: PCT/IL2006/001128

§ 371 Date: Mar. 11, 2008

Related U.S. Application Data
(60) Provisional application No. 60/721,079, filed on Sep. 28, 2005.

(51) Int. Cl. G02B 27/22

(52) U.S. Cl. 359/466

(57) ABSTRACT

An optical system for transmitting a stereoscopic image to a right eye and a left eye of a user is disclosed. The system comprises an optical relay device, having a light-transmissive substrate, an input grating, a left output grating and a right output grating. The optical relay device is designed and constructed such that light is diffracted by the input grating, propagates within the light-transmissive substrate via total internal reflection, and diffracted out of the light-transmissive substrate by at least one of the left and right output gratings. The system further comprises an image generating system, optically coupled to the input grating and configured for providing collimated light constituting a left-eye image and a right-eye image wherein the left-eye image is parallactically related to the right-eye image. In various exemplary embodiments of the invention the left-eye image and the right-eye image are spectrally modulated according to different spectral maps, selected to provide different optical information to different eyes.

### FIELD AND BACKGROUND OF THE INVENTION

The present invention relates to optics, and, more particularly, to a stereoscopic binocular system, device and method.

A viewer of a two-dimensional image perceives a structure such as depth, thickness or the like, when the two-eyes of the viewer see slightly different images of a three-dimensional scene. The brain of the viewer transforms the different images viewed by the left eye and right eye into information relating to the third dimension of the image, and the image appears to be “three-dimensional”. A technique in which such structures are visually understood is known as stereoscopy.

Stereoscopic displays are largely demanded in many fields, including, virtual reality simulation, telecommunication, entertainment, structure designed, medical imaging and the like. Hitherto, various kinds of studies and developments have been executed with respect to a display which can stereoscopically present an image. Generally, an electronic display may provide a real image, the size of which is determined by the physical size of the display device, or a virtual image, the size of which may extend the dimensions of the display device.

A real image is defined as an image, projected on or displayed by a viewing surface positioned at the location of the image, and observed by an unaided human eye (to the extent that the viewer does not require corrective glasses). Examples of real image displays include a cathode ray tube (CRT), a liquid crystal display (LCD), an organic light emitting diode array (OLED), or any screen-projected displays. A real image could be viewed normally from a distance of about at least 25 cm, the minimal distance at which the human eye can utilize focus onto an object. Unless a person is long-sighted, he may not be able to view a sharp image at a closer distance.

Typically, desktop computer systems and workplace computing equipment utilize CRT display screens to display images for a user. The CRT displays are heavy, bulky and not easily miniaturized. For a laptop, a notebook, or a palm computer, flat-panel display is typically used. The flat-panel display may use LCD technology implemented as passive matrix or active matrix panel. The passive matrix LCD panel consists of a grid of horizontal and vertical wires. Each intersection of the grid constitutes a single pixel, and controls an LCD element. The LCD element either allows light through or blocks the light. The active matrix panel uses a transistor to control each pixel, and is more expensive. An OLED flat panel display is an array of light emitting diodes, made of organic polymeric materials. Existing OLED flat panel displays are based on both passive and active configurations. Unlike the LCD display, which controls light transmission or reflection, an OLED display emits light, the intensity of which is controlled by the electrical bias applied thereto. Flat-panels are also used for miniature image display systems because of their compactness and energy efficiency compared to the CRT displays.

A known technique for presenting an electronic stereo pair signal to provide a viewer with a “three-dimensional” real image is temporal multiplexing. Two different images are provided in a temporally alternating sequential manner to a real image display, such that, at any point in time, only one image is present and visible. Downstream of the image display device, the system includes elements for enabling the left eye of the viewer to see only one image and for enabling the right eye of the viewer to see only the other image. This is typically achieved by having the viewer wear shuttering eyeglasses that are linked to, and synchronized with, the image display device. In another temporal multiplexing scheme, the image display device is overlaid by a fast switching polarizing device which polarizes the left-eye image one way and the right-eye image orthogonally so that the observer can simply wear passive polarizing glasses with the axis of polarization of the left-eye glass orthogonal to that of the right eye.

In another technique, the two images are spatially multiplexed over the real image display. Typically, compressed columns of the left-eye image and the right-eye image are spatially alternated in the image signal. The spatially multiplexed image signal is then fed into the real image display. Polarizing micro strips positioned in front of the display ensure that columns belonging to the left-eye image are polarized along one polarization axis and columns belonging to the right-eye image are polarized along another polarization axis. The two polarization axes are orthogonal and the stereoscopic image can be viewed with passive polarizing glasses which are compatible with the two polarization axes.

Stereoscopic vision can also be achieved when the left-eye and right-eye images have limited, but different, color contents. Specifically, the left-eye image is limited in color content to one half of the visible light spectrum, and the right-eye image is limited in color content to the remaining half of the visible light spectrum. The two images superimposed over the real image display to form an anaglyph that can be viewed by placing a different color filter in front of each eye. The filters are substantially mutually exclusive to permit each eye to see only one of the two limited color contents.

Small size real image stereoscopic displays are hardly attainable because they have a relatively small surface area on which to present a real image, thus have limited capability for providing sufficient information to the user.

By contrast to a real image, a virtual image is defined as an image, which is not projected onto or emitted from a viewing surface, and no light ray connects the image and an observer. A virtual image can only be seen through an optic element, for example a typical virtual image can be obtained from an object placed in front of a converging lens, between the lens and its focal point. Light rays, which are reflected from an individual point on the object, diverge when passing through the lens, thus no two rays share two endpoints. An observer, viewing from the other side of the lens would perceive an image, which is located behind the object, hence enlarged. A virtual image of an object, positioned at the focal plane of a lens, is said to be projected to infinity. A virtual image display system, which includes a miniature display panel and a lens, can enable viewing of a small size, but high content display, from a distance much smaller than 25 cm. Such a display system can provide a viewing capability which is equivalent to a high content, large size real image display system, viewed from much larger distance.

Conventional virtual image displays are known to have many shortcomings. For example, such displays have suffered from being too heavy for comfortable use, as well as too large so as to be obtrusive, distracting and even disorienting. These defects stem from, inter alia, the incorporation of relatively large optics systems within the mounting structures, as well as physical designs which fail to adequately take into account important factors as size, shape, weight, etc.

Recently, holographic optical elements have been used in portable virtual image displays. Holographic optical elements serve as an imaging lens and a combiner where a two-dimensional, quasi-monochromatic display is imaged to infinity and reflected into the eye of an observer. A common problem to all types of holographic optical elements is their relatively high chromatic dispersion. This is a major drawback in applications where the light source is not purely monochromatic. Another drawback of some of these displays is the lack of coherence between the geometry of the image and the geometry of the holographic optical element, which causes aberrations in the image array that decrease the image quality.

New designs, which typically deal with a single holographic optical element, compensate for the geometric and chromatic aberrations by using non-spherical waves rather than simple spherical waves for recording; however, they do not overcome the chromatic dispersion problem. Moreover, with these designs, the overall optical systems are usually very complicated and difficult to manufacture. Furthermore, the field-of-view resulting from these designs is usually very small.

U.S. Pat. No. 6,757,105 to Niv et al., the contents of which are hereby incorporated by reference, provides a diffractive optical element for optimizing a field-of-view for a multicolor spectrum. The optical element includes a light-transmissive substrate and a linear grating formed therein. Niv et al. teach how to select the pitch of the linear grating and the refraction index of the light-transmissive substrate so as to trap a light beam having a predetermined spectrum and characterized by a predetermined field of view to propagate within the light-transmissive substrate via total internal reflection. Niv et al. also disclose an optical device incorporating the aforementioned diffractive optical element for transmitting light in general and images in particular into the eye of the user.

The above virtual image devices, however, provide a single optical channel, hence allowing the scene of interest to be viewed by one eye. It is recognized that the ability of any virtual image devices to transmit an image without distortions inherently depends on whether or not light rays emanating from all points of the image are successfully transmitted to the eye of the user in their original color. Due to the single optical channel employed by presently known devices, the filed-of-view which can be achieved without distortions or loss of information is rather limited. Furthermore, a single optical channel cannot provide a stereoscopic image.

A binocular device which employs several diffractive optical elements is disclosed in U.S. patent application Ser. Nos. 10/896,865 and 11/017,920, and in International Patent Application, Publication No. WO 2006/008734, the contents of which are hereby incorporated by reference. An optical relay is formed of a light transmissive substrate, an input diffractive optical element and two output diffractive optical elements. Collimated light is diffracted into the optical relay by the input diffractive optical element, propagates in the substrate via total internal reflection and coupled out of the optical relay by two output diffractive optical elements. The input and output diffractive optical elements preserve relative angles of the light rays to allow transmission of images with minimal or no distortions. The output elements are spaced apart such that light diffracted by one element is directed to one eye of the viewer and light diffracted by the other element is directed to the other eye of the viewer. The binocular design of these references significantly improves the field-of-view. The images provided by the above systems are viewed by the user as planar images.

U.S. Pat. No. 6,882,479 to Song et al. discloses a wearable display system for producing a “three-dimensional” image. The display includes a display panel which outputs an optical signal and a waveguide which guides the propagation of the signal. The signal is diffracted out of the waveguide by two gratings, and magnified by magnifying lenses. Two shutters are used for alternately blocking the outgoing light. The wearable display system operates on the principle that a three-dimensional effect is realized when the same image reaches the eyes of the user with a time difference.

The present invention provides solutions to the problems associated with prior art stereoscopic techniques.

### SUMMARY OF THE INVENTION

According to one aspect of the present invention there is provided an optical system for transmitting a stereoscopic image to a right eye and a left eye of a user. The system comprises an optical relay device and an image generating system. The optical relay device has a light-transmissive substrate, an input grating, a left output grating and a right output grating. The image generating system is optically coupled to the input grating and configured for providing the input grating with collimated light constituting a left-eye image, spectrally modulated according to a first spectral map, and a right-eye image, spectrally modulated according to a second spectral map.

According to another aspect of the present invention there is provided a method of transmitting a stereoscopic image to a right eye and a left eye of a user, The method comprises: (a) providing collimated light constituting a left-eye image, spectrally modulated according to a first spectral map, and a right-eye image, spectrally modulated according to a second spectral map; (b) using an input grating for diffracting the collimated light in a manner such that the light propagates within a light-transmissive substrate via total internal reflection; (c) using a left output grating for diffracting light rays of the left-eye image out of the light-transmissive substrate; and (d) using a right output grating for diffracting light rays of the right-eye image out of the light-transmissive substrate.

According to further features in preferred embodiments of the invention described below, the left-eye image is parallactically related to the right-eye image, and the first spectral map is spectrally complementary to the second spectral map.

According to still further features in the described preferred embodiments the first spectral map is selected such that at least a few light rays of the left-eye image are diffracted by the input grating, propagate in the light transmissive substrate via total internal reflection and impinge on the left output grating but not on the right output grating Similarly, the second spectral map is selected such that at least a few light rays of the right-eye image are diffracted by the input grating, propagate in the light transmissive substrate via total internal reflection and impinge on the right output grating but not on the left output grating.

According to still further features in the described preferred embodiments the few light rays of the left-eye image constitute off-central regions of the left-eye image, and the few light rays of the right-eye image constitute off-central regions of the right-eye image.

According to still further features in the described preferred embodiments the left-eye image is superimposed onto the right-eye image such that central regions of the left-eye image are spatially interlaced with central regions of the right-eye image, thereby forming an interlaced image region.

According to still further features in the described preferred embodiments each of the first and second spectral maps is selected so as to minimize the interlaced image region.

According to still further features in the described preferred embodiments each of the first and second spectral maps is selected such that light rays constituting the interlaced image region are diffracted by the input grating, propagate in the light transmissive substrate via total internal reflection and impinge on the left and the right output gratings.

According to still further features in the described preferred embodiments each of the first and second spectral maps is characterized by a color gradient across the respective image.

According to still further features in the described preferred embodiments the first spectral map is selected so as to ensure that a left part of the left-eye image is limited in color content to wavelengths higher than a first predetermined threshold, and a right part of the left-eye image is limited in color content to wavelengths lower than a second predetermined threshold.

According to still further features in the described preferred embodiments the second spectral map is selected so as to ensure that a right part of the right-eye image is limited in color content to wavelengths higher than a first predetermined threshold, and a left part of the right-eye image is limited in color content to wavelengths lower than a second predetermined threshold.

According to still further features in the described preferred embodiments the first predetermined threshold substantially equals the second predetermined threshold.

According to still further features in the described preferred embodiments the first predetermined threshold is lower than the second predetermined threshold.

According to still further features in the described preferred embodiments the system further comprises an image processor configured for spectrally modulating the left-eye image according to the first spectral map and for spectrally modulating the right-eye image according to the second spectral map.

According to still further features in the described preferred embodiments the system further comprises a memory medium associated with the image processor and configured for storing the first spectral map and the second spectral map.

According to still further features in the described preferred embodiments the collimated light is provided by spectrally modulating the left-eye image according to the first spectral map, and spectrally modulating the right-eye image according to the second spectral map.

According to yet another aspect of the present invention there is provided a binocular device for transmitting a stereoscopic image to a right eye and a left eye of a user. The binocular device being optically coupleable to an image generating system configured for providing collimated light constituting, in a temporally alternating manner, a left-eye image and a right-eye image having a parallactic relation thereamongst. The binocular device comprises an optical relay device as described above; and an image separating device positioned in front of the optical relay device and configured for substantially preventing light constituting the left-eye image from arriving at the right eye, and light constituting the right-eye image from arriving at the left eye, thereby to separate the left-eye image from the right-eye image.

According to still another aspect of the present invention there is provided an optical system for transmitting a stereoscopic image to a right eye and a left eye of a user. The system comprises: an image generating system configured for providing collimated light constituting, in a temporally alternating manner, a left-eye image and a right-eye image having a parallactic relation thereamongst; an optical relay device as described above; and an image separating device as described above.

According to further features in preferred embodiments of the invention described below, the optical relay device is designed and constructed such that light is diffracted by the input grating, propagates within the light-transmissive substrate via total internal reflection, and diffracted out of the light-transmissive substrate by at least one of the left and right output gratings.

According to still further features in the described preferred embodiments the input grating is a single grating and the image generating system is optically coupled to the input grating such that both the left-eye image and the right-eye image are diffracted by the input grating.

According to still further features in the described preferred embodiments the image separating device comprises a left electronic shutter positioned in front of the left output grating and a right electronic shutter positioned in front of the right output grating, the left and the right electronic shutters being synchronized with the image generating system.

According to still further features in the described preferred embodiments the left and the right electronic shutters are liquid crystal shutters.

According to other features in the described preferred embodiments the left and the right electronic shutters are electrooptical shutters and the image separating device further comprises a left polarization analyzer positioned in front of the left electronic shutter, and a right polarization analyzer positioned in front of the right electronic shutter.

According to still further features in the described preferred embodiments the input grating is designed and constructed such that: (i) light rays impinging on the input grating at an angle within a first partial field-of-view and having wavelengths within a first sub-spectrum are diffracted by the input grating, propagate via total internal reflection, and impinge on the left output grating but not on the right output grating; and (ii) light rays impinging on the input grating at an angle within the first partial field-of-view and having wavelengths within a second sub-spectrum are diffracted by the input grating, propagate via total internal reflection, and impinge on the right output grating but not on the left output grating.

According to still further features in the described preferred embodiments the input grating is further designed and constructed such that: (iii) light rays impinging on the input grating at an angle within a second partial field-of-view and having wavelengths within the first sub-spectrum are diffracted by the input grating, propagate via total internal reflection, and impinge on the right output grating but not on the left output grating; and (iv) light rays impinging on the input grating at an angle within the second partial field-of-view and having wavelengths within the second sub-spectrum are diffracted by the input grating, propagate via total internal reflection, and impinge on the left output grating but not on the right output grating.

According to still further features in the described preferred embodiments the first partial field-of-view is from a first clockwise angle to a first anticlockwise angle, the second partial field-of-view is from a second clockwise angle to a second anticlockwise angle, the first sub-spectrum is characterized by wavelengths below a first threshold, and the second sub-spectrum is characterized by wavelengths above a second threshold.

According to still further features in the described preferred embodiments the image generating system comprises a light source, at least one image carrier and a collimator for collimating light produced by the light source and reflected or transmitted through the at least one image carrier.

According to still further features in the described preferred embodiments the image generating system comprises at least one miniature display and a collimator for collimating light produced by the at least one miniature display.

According to still further features in the described preferred embodiments the image generating system comprises a light source, configured to produce light modulated by imagery data, and a scanning device for scanning the light modulated imagery data onto the optical relay device.

The present invention successfully addresses the shortcomings of the presently known configurations by providing a device, system and method for providing a stereoscopic vision of a three-dimensional scene to the eyes of the user.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of light diffraction by a linear diffraction grating operating in transmission mode;

FIGS. 2a-d are schematic illustrations of a system for transmitting a stereoscopic image to a right eye and a left eye of a user, according to various exemplary embodiments of the present invention;

FIG. 3 is a schematic illustration of a spectral map which can be used for modulating parallactic images, according to various exemplary embodiments of the present invention;

FIGS. 4a-c are schematic illustrations of a wearable device, according to various exemplary embodiments of the present invention; and

FIGS. 5a-b are fragmentary views schematically illustrating wavefront propagation within the optical relay device, according to preferred embodiments of the present invention.

### DESCRIPTION OF THE PREFERRED EMBODIMENTS

The present embodiments comprise system, device and method which can be used providing virtual images. Specifically the present embodiments can be used for providing stereoscopic vision of a three-dimensional scene to the eyes of the user.

The principles and operation of the optical system according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

When a ray of light moving within a light-transmissive substrate and striking one of its internal surfaces at an angle φ₁ as measured from a normal to the surface, it can be either reflected from the surface or refracted out of the surface into the open air in contact with the substrate. The condition according to which the light is reflected or refracted is determined by Snell's law, which is mathematically realized through the following equation:

n_{A} sin φ₂=n_{S} sin φ₁, (EQ. 1)

where n_{S} is the index of refraction of the light-transmissive substrate, n_{A} is the index of refraction of the medium outside the light transmissive substrate (n_{S}>n_{A}), and φ₂ is the angle in which the ray is refracted out, in case of refraction. Similarly to φ₁, φ₂ is measured from a normal to the surface. A typical medium outside the light transmissive substrate is air having an index of refraction of about unity.

As used herein, the term “about” refers to ±10%.

As a general rule, the index of refraction of any substrate depends on the specific wavelength λ of the light which strikes its surface. Given the impact angle, φ₁, and the refraction indices, n_{S} and n_{A}, Equation 1 has a solution for φ₂ only for φ₁ which is smaller than arcsine of n_{A}/n_{S} often called the critical angle and denoted α_{c}. Hence, for sufficiently large φ₁ (above the critical angle), no refraction angle φ₂ satisfies Equation 1 and light energy is trapped within the light-transmissive substrate. In other words, the light is reflected from the internal surface as if it had stroked a mirror. Under these conditions, total internal reflection is said to take place. Since different wavelengths of light (i.e., light of different colors) correspond to different indices of refraction, the condition for total internal reflection depends not only on the angle at which the light strikes the substrate, but also on the wavelength of the light. In other words, an angle which satisfies the total internal reflection condition for one wavelength may not satisfy this condition for a different wavelength.

When a sufficiently small object or sufficiently small opening in an object is placed in the optical path of light, the light experiences a phenomenon called diffraction in which light rays change direction as they pass around the edge of the object or at the opening thereof. The amount of direction change depends on the ratio between the wavelength of the light and the size of the object/opening. In planar optics there is a variety of optical elements which are designed to provide an appropriate condition for diffraction. Such optical elements are typically manufactured as diffraction gratings which are located on a surface of a light-transmissive substrate. Diffraction gratings can operate in transmission mode, in which case the light experiences diffraction by passing through the gratings, or in reflective mode in which case the light experiences diffraction while being reflected off the gratings

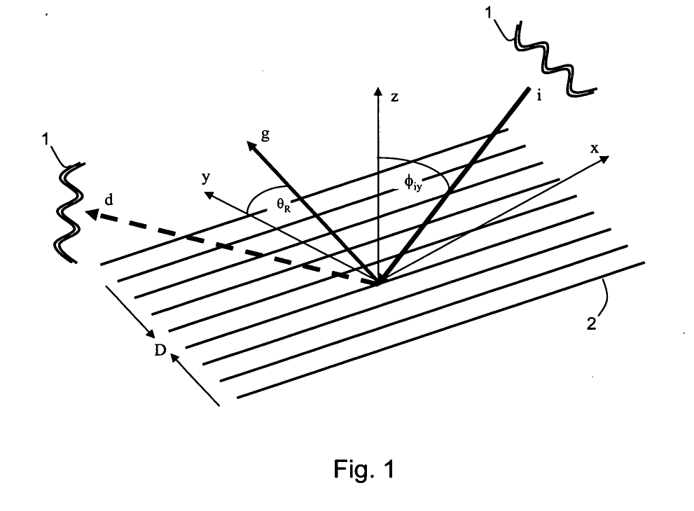

FIG. 1 schematically illustrates diffraction of light by a linear diffraction grating operating in transmission mode. One of ordinary skills in the art, provided with the details described herein would know how to adjust the description for the case of reflection mode.

A wavefront 1 of the light propagates along a vector i and impinges upon a grating 2 engaging the x-y plane. The normal to the grating is therefore along the z direction and the angle of incidence of the light 4, is conveniently measured between the vector i and the z axis. In the description below, φ_{iy} is decomposed into two angles, φᵢₓ and φ_{iy}, where φᵢₓ is the incidence angle in the z-x plane, and φ_{iy} is the incidence angle in the z-y plane. For clarity of presentation, only φ_{iy} is illustrated in FIG. 1.

The grating has a periodic linear structure along a vector g, forming an angle θ_{R} with the y axis. The period of the grating (also known as the grating pitch) is denoted by D. The grating is formed on a light transmissive substrate having an index of refraction denoted by n_{S}.

Following diffraction by grating 2, wavefront 1 changes its direction of propagation. The principal diffraction direction which corresponds to the first order of diffraction is denoted by d and illustrated as a dashed line in FIG. 1. Similarly to the angle of incidence, the angle of diffraction φ_{d}, is measured between the vector d and the z axis, and is decomposed into two angles, φ_{dx} and φ_{dy}, where φ_{dx} is the diffraction angle in the z-x plane, and φ_{dy} is the diffraction angle in the z-y plane.

The relation between the grating vector g, the diffraction vector d and the incident vector i can therefore be expressed in terms of five angles (θ_{R}, φᵢₓ, φ_{iy}, φ_{dx} and φ_{dy}) and it generally depends on the wavelength λ of the light and the grating period D through the following pair of equations:

sin(φᵢₓ)−n_{S} sin(φ_{dx})=(λ/D) sin(θ_{R}) (EQ. 2)

sin(φᵢₓ)+n_{S} sin(φ_{dy})=(λ/D) cos(θ_{R}). (EQ. 3)

Without the loss of generality, the Cartesian coordinate system can be selected such that the vector i lies in the y-z plane, hence sin(φᵢₓ)=0. In the special case in which the vector g lies along the y axis, θ_{R}=0° or 180°, and Equations 2-3 reduce to the following one-dimensional grating equation:

sin φ_{iy}+n_{S} sin φ_{dy}=±λ/d. (EQ. 4)

According the known conventions, the sign of φᵢₓ, φ_{iy}, φ_{dx} and φ_{dy} is positive, if the angles are measured clockwise from the normal to the grating, and negative otherwise. The dual sign on the RHS of the one-dimensional grating equation relates to two possible orders of diffraction, +1 and −1, corresponding to diffractions in opposite directions, say, “diffraction to the right” and “diffraction to the left,” respectively.

A light ray, entering a substrate through a grating, impinge on the internal surface of the substrate opposite to the grating at an angle which depends on the two diffraction components sin(φ_{dx}) and sin(φ_{dy}) according to the following equation:

φd=sin⁻¹{[sin²(φ_{dx})+sin²(φ_{dy})]^{1/2}} (EQ. 5)

When φ_{d} is larger than the critical angle α_{c}, the wavefront undergoes total internal reflection and begin to propagate within the substrate.

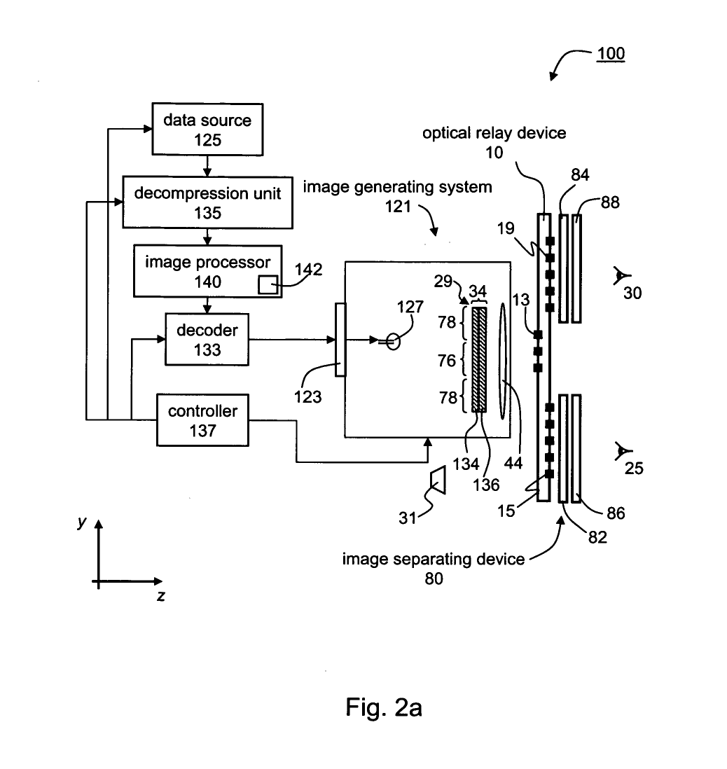

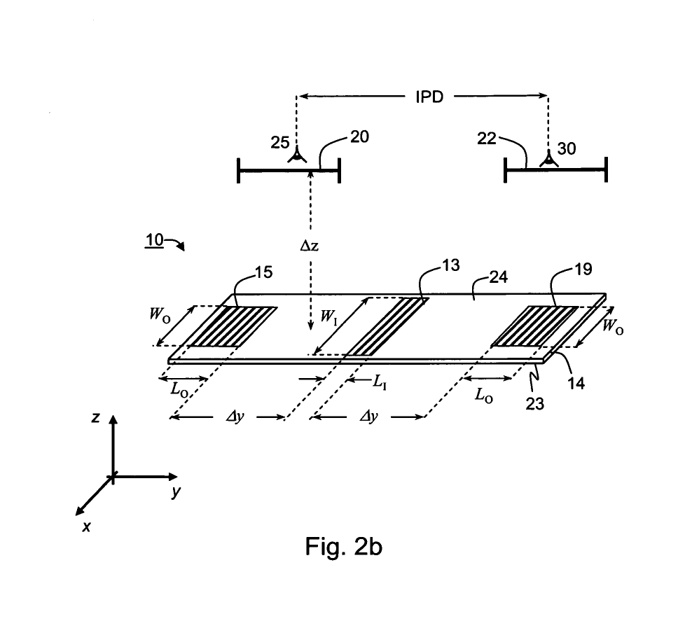

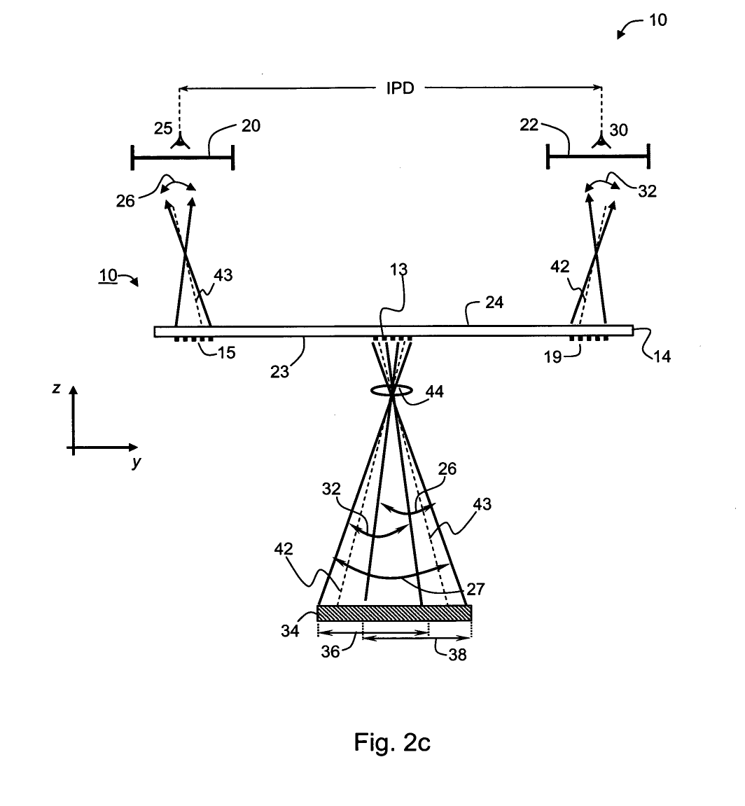

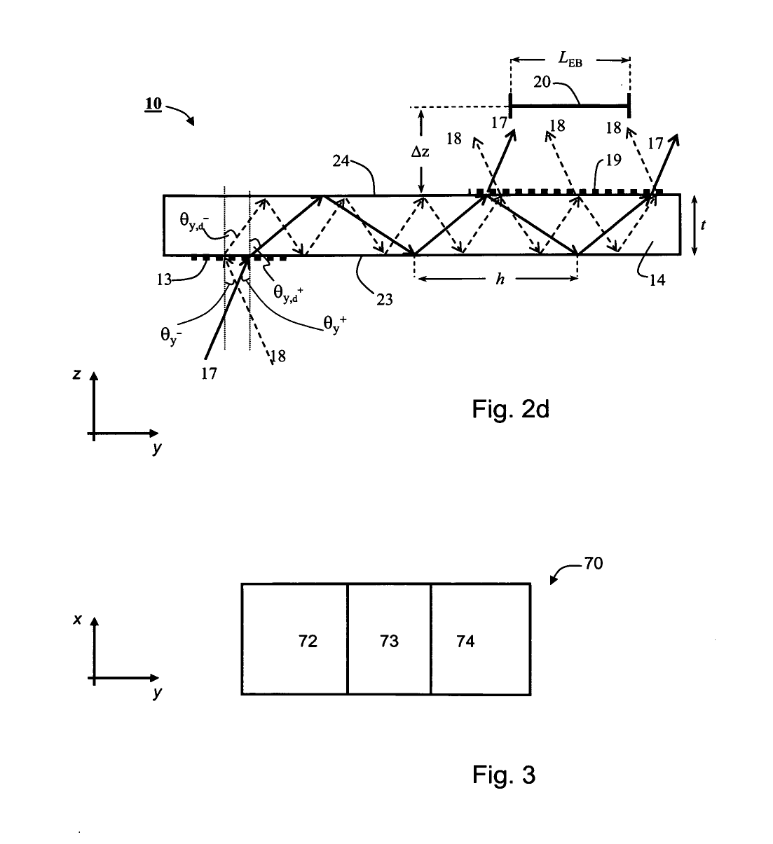

Reference is now made to FIGS. 2a-d which are schematic illustrations of a system 100 for transmitting a stereoscopic image to a left eye 25 and a right eye 30 of a user. In its simplest configuration, system 100 comprises an image generating system 121 and an optical relay device 10. Image generating system 121 is configured to provide device 10 with two parallactically related images: a left-eye image 134 and a right-eye image 136.

The term “parallactically related images” refers to images having parallax for the right and left eyes. For example, when it is desired to capture parallactically related images of a real scene, a stereoscopic camera can be arrayed to capture images of the same scene from two different viewing positions corresponding to the average interpupillary distance. The term “stereoscopic camera” is commonly understood by those skilled in the art to mean the combination of a left and a right camera linked together for the purpose of generating stereoscopic images.

Left-eye image 134 and right-eye image 136 are preferably superimposed to form a stereoscopic image 34. For the purpose of clarity of presentation, the left- and right-eye images are illustrated as two parallel images, but, as will be appreciated by one of ordinary skill in the art, the two superimposed images are typically coplanar and may be partially or fully overlapping. Left-eye image 134 and right-eye image 136 can also be displayed sequentially, as further discussed below.

Furthermore, although left-eye image 134, right-eye image 136 and the combined stereoscopic image 34 are illustrated as tangible objects, this need not necessarily be the case, since, for some applications, it may not be necessary for the images to be tangible objects. For example, images can be formed by light rays performing, e.g., a raster scan.

The terms “left-eye image”, “right-eye image” and “stereoscopic image”, as used herein, refer to the images constituted by the collimated light while impinging on the optical relay device.

A perspective view of optical relay device 10 is illustrated in FIGS. 2b, and a side view of optical relay device 10 is illustrated in FIG. 2c. In various exemplary embodiments of the invention optical relay device 10 comprises a light-transmissive substrate 14, an input grating 13, a left output grating 15 and a right output grating 19, where grating 15 is laterally displaced from grating 19. Preferably, grating 13 is laterally displaced from both output gratings 15 and 19. The lateral displacement between the input grating and the left or right output grating is generally denoted Δy. In various exemplary embodiments of the invention the lateral displacement between the input grating and the left output grating substantially equals the lateral displacement between the input grating and the right output grating.

The system of coordinates in FIGS. 2a-d is selected such that substrate 14 is orthogonal to the z axis, and gratings 13, 15 and 19 are laterally displaced along the y axis. Generally, the z axis is referred to as the “normal axis”, the y axis is referred to as the “longitudinal axis” and the x axis is referred to as the “transverse axis” of device 10. Thus, substrate 14 engages a plane spanned by the longitudinal direction (the y direction in the present coordinate-system) and the transverse direction (the x direction in the present coordinate system).

Grating 13 diffracts the light into substrate 14 such that at least a few light rays experience total internal reflection and propagate within substrate 14, and gratings 15 and 19 diffract at least a few of the propagating light rays out of substrate 14.

The term “diffracting” as used herein, refers to a change in the propagation direction of a wavefront, in either a transmission mode or a reflection mode. In a transmission mode, “diffracting” refers to change in the propagation direction of a wavefront while passing through the grating other than the change in direction due to Snell's Law; in a reflection mode, “diffracting” refers to change in the propagation direction of a wavefront while reflecting off the grating in an angle different from the basic reflection angle (which is identical to the angle of incidence).

In various exemplary embodiments of the invention a single input grating is employed, whereby the 121 image generating system is optically coupled to the input grating such that both the left-eye image and the right-eye image are diffracted by the input grating.

Input grating 13 is designed and constructed such that the angle of light rays diffracted thereby is above the critical angle, and the light propagates in the substrate via total internal reflection. The propagated light, after a few reflections within substrate 14, reaches output gratings 15 and 19 which diffract the light out of substrate 14. Any one of gratings 13, 15 and 19 is preferably a linear grating, operating according to the principles described above. When two or more of the gratings are linear gratings, their periodic linear structures are preferably substantially parallel, and the corresponding grating periods are substantially equal. Under such conditions, the light rays diffracted out of the substrate by the output grating(s) are substantially parallel to the corresponding light rays which are incident on the input grating.

Device 10 is preferably designed to transmit light striking substrate 14 at any striking angle within a predetermined range of angles, which predetermined range of angles is referred to of the field-of-view of the device.

The input grating is designed to trap all light rays in the field-of-view within the substrate. A field-of-view can be expressed either inclusively, in which case its value corresponds to the difference between the minimal and maximal incident angles, or explicitly in which case the field-of-view has a form of a mathematical range or set. Thus, for example, a field-of-view, Ω, spanning from a minimal incident angle, α, to a maximal incident angle, β, is expressed inclusively as Ω=β−α, and exclusively as Ω=[α, β]. The minimal and maximal incident angles are also referred to as rightmost and leftmost incident angles or counterclockwise and clockwise field-of-view angles, in any combination. The inclusive and exclusive representations of the field-of-view are used herein interchangeably.

FIG. 2d is a fragmentary side view of the right part of device 10. The field-of-view of device 10 is illustrated in FIG. 2d by two of its outermost light rays, generally shown at 17 and 18. Note that FIG. 2d illustrates the projections of rays 17 and 18 on a plane containing the longitudinal axis of device 10 (the y-z plane in the present coordinate system). The projection of ray 18 is the rightmost ray projection which forms with the normal axis an angle denoted θ_{y}⁻, and the projection of ray 17 is the leftmost ray projection which forms with the normal axis an angle denoted θ_{y}⁺.

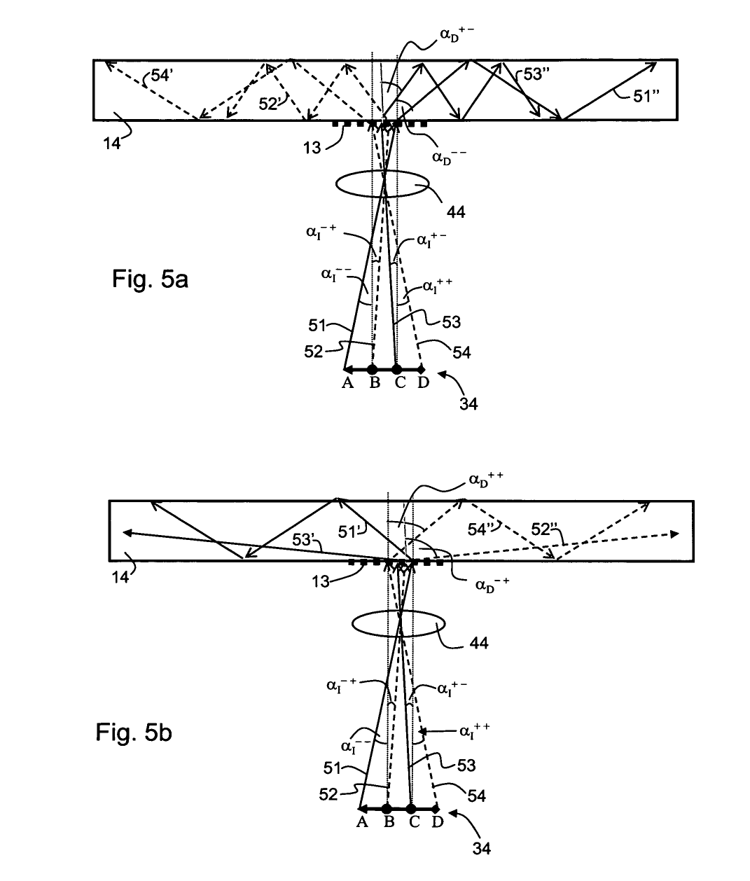

In FIG. 2c, left 15 and right 19 output gratings are formed, together with input grating 13, on surface 23 of substrate 14. However, this need not necessarily be the case, since gratings 13, 15 and 19 can be formed on or attached to any of the surfaces 23 and 24 of substrate 14. One ordinarily skilled in the art would appreciate that this corresponds to any combination of transmissive and reflective gratings. Thus, for example, suppose that the input grating is formed on surface 23 of substrate 14 and both output gratings are formed on surface 24. Suppose further that the light impinges on surface 23 and it is desired to diffract the light out of surface 24. In this case, the input grating and the two output gratings are all transmissive, so as to ensure that entrance of the light through the input grating, and the exit of the light through the output gratings. Alternatively, if the input and output gratings are all formed on surface 23, then the input grating remain transmissive, so as to ensure the entrance of the light therethrough, while the output gratings are reflective, so as to reflect the propagating light at an angle which is sufficiently small to couple the light out. In such configuration, light can enter the substrate through the side opposite the input grating, be diffracted in reflection mode by the input grating, propagate within the light transmissive substrate in total internal diffraction and be diffracted out by the output gratings operating in a transmission mode. Wavefront propagation within substrate 14, according to various exemplary embodiments of the present invention, is further detailed hereinunder with reference to FIGS. 5a-b.

Substrate 14 can be made of any light transmissive material, preferably, but not obligatorily, a martial having a sufficiently low birefringence. Grating 15 is laterally displaced from grating 13. A preferred lateral separation between the gratings is from a few millimeters to a few centimeters.

In the representative illustration of FIG. 2d, grating 13 diffracts leftmost ray 17 and rightmost ray 18 into substrate 14 at diffraction angles denoted θ_{d}⁺ and θ_{d}⁻, respectively. Shown in FIG. 2d are θ_{yd}^{±} which are the projections of θ_{d}^{±} on the y-z plane.

While propagating, the rays are reflected from the internal surfaces of substrate 14. The Euclidian distance between two successive points on the internal surface of the substrate at which a particular light ray experiences total internal reflection is referred to as the “hop length” of the light ray and denoted by “h”. The propagated light, after a few reflections within substrate 14, generally along the longitudinal axis of device 10, reaches one or both the output gratings which redirect the light out of substrate 14. Device 10 thus transmits at least a portion of the optical energy carried by each light ray between rays 17 and 18. When the light rays within the field-of-view originate from an object which emits or reflects light, a viewer can position the left eye in front of grating 15 and the right eye in front of grating 19 to see a virtual image of the object.

As shown in FIG. 2d, for a single impingement of a light ray on the output grating 19, only a portion of the light energy exits the substrate. The remnant of each ray is redirected through an angle, which causes it, again, to experience total internal reflection from the other side of the substrate. After such a reflection, the remnant may re-strike the output grating, and upon each such re-strike, an additional part of the light energy exits the substrate. Thus, a light ray propagating in the substrate via total internal reflection exits the substrate in a form of a series of parallel light rays where the distance between two adjacent light rays in the series is h. Such series of parallel light rays corresponds to a collimated light beam exiting the output grating. Since more than one light ray exit as a series of parallel light rays, a beam of light passing through device 10 is expanded in a manner that the cross sectional area of the outgoing beam is larger than cross sectional area of the incoming beam.

As can be understood from the geometrical configuration illustrated in FIG. 2d, the angles at which light rays 18 and 17 are redirected can differ. As the angles of redirection depend on the incident angles (see Equations 2-5), the allowed clockwise (θ_{y}⁺) and anticlockwise (θ_{y}⁻) field-of-view angles, are also different. Thus, device 10 supports transmission of asymmetric field-of-view in which, say, the clockwise field-of-view angle is greater than the anticlockwise field-of-view angle. The difference between the absolute values of the clockwise and anticlockwise field-of-view angles can reach more than 70% of the total field-of-view.

Thus, grating 13 preferably diffracts the incoming light into substrate 14 in a manner such that different portions of the light, corresponding to different partial fields-of-view, propagate in different directions within substrate 14. In the configuration exemplified in FIG. 2c, grating 13 redirects light rays within one asymmetric partial field-of-view, designated by reference numeral 26, to impinge on grating 15, and another asymmetric partial field-of-view, designated by reference numeral 32, to impinge on grating 19. Gratings 15 and 19 complementarily redirect the respective portions of the light, or portions thereof, out of substrate 14, to provide left eye 25 with partial field-of-view 26 and right eye 30 with partial field-of-view 32.

Partial field-of-view 32 generally include all light rays impinging on grating 13 at an angle from a first clockwise angle, to a first anticlockwise angle, and partial field-of-view 26 generally include all light rays impinging on grating 13 at an angle from a second clockwise angle to a second anticlockwise angle. The clockwise/anticlockwise partial field-of-view angles are denoted α⁻⁻, α⁻⁺, α⁺⁻ and α⁺⁺, as further detailed hereinunder with reference to FIGS. 5a-b.

Partial field-of-views 26 and 32 form together the field-of-view 27 of device 10. When the light rays originate from an image 34, field-of-view 27 preferably includes substantially all light rays originated from the image. Partial fields-of-view 26 and 32 can therefore correspond to different parts of image 34, which different parts are designated in FIG. 2c by numerals 36 and 38. Thus, as shown in FIG. 2c, there is at least one light ray 42 which enters device 10 via grating 13 and exits device 10 via grating 19 but not via grating 15. Similarly, there is at least one light ray 43 which enters device 10 via grating 13 and exits device 10 via grating 15 but not via grating 19.

The human visual system is known to possess a physiological mechanism capable of inferring a complete image based on several parts thereof, provided sufficient information reaches the retinas. This physiological mechanism operates on monochromatic as well as chromatic information received from the rod cells and cone cells of the retinas. Thus, in a cumulative nature, the two asymmetric field-of-views, reaching each individual eye, form a combined field-of-view perceived by the user, which combined field-of-view is wider than each individual asymmetric field-of-view.

According to a preferred embodiment of the present invention, there is a predetermined overlap between first 26 and second 32 partial fields-of-view, which overlap allows the user's visual system to combine parts 36 and 38 of image 34, thereby to perceive the image, as if it has been fully observed by each individual eye.

For example, the gratings can be constructed such that the exclusive representations of partial fields-of-view 26 and 32 are, respectively, [−α, β] and [−β, α], resulting in a symmetric combined field-of-view 27 of [−β, β]. It will be appreciated that when β>>α>0, the combined field-of-view is considerably wider than each of the asymmetric field-of-views. Device 10 is capable of transmitting a field-of-view of at least 20 degrees, more preferably at least 30 degrees most preferably at least 40 degrees, in inclusive representation.

Generally, the partial field-of-views, hence also the parts of the image arriving to each eye depend on the wavelength of the light. When the image is a multicolor image having a spectrum of wavelengths, different sub-spectra correspond to different, wavelength-dependent, asymmetric partial field-of-views. Therefore, for wavelengths within one sub-spectrum, say a sub-spectrum characterized by wavelengths above a first threshold, λ₁, partial field-of-view 32 is viewed by eye 25 and partial field-of-view 26 is viewed by eye 30, while for wavelengths within another sub-spectrum, say a sub-spectrum characterized by wavelengths below a second threshold, λ₂≧λ₁, partial field-of-view 32 is viewed by eye 30 and partial field-of-view 26 is viewed by eye 25. For example, when the image is constituted by a light having three colors: red, green and blue, device 10 can be constructed such that eye 25 sees part 38 of the image for the blue light and part 36 for the red light, while eye 30 sees part 36 for the blue light and part 38 for the red light. In such configuration, both eyes see an almost symmetric field-of-view for the green light. Thus, for every color, the two partial fields-of-view compliment each other.

Thus, whether or not a particular light ray originated from the image arrives at a particular eye, depends on the wavelength of the light ray and on the location on the image from which the light ray is originated. The optical relay device is therefore characterized by two “spectral maps,” each representing, for each location on the image, the range of wavelengths that can be seen by one eye. Preferably, the two spectral maps spectrally complement each other.

The two different spectral maps characterizing the optical relay device are exploited in accordance with various exemplary embodiments of the present invention, to provide different images to the left and right eyes.

Hence, according to various exemplary embodiments of the present invention image 134 is spectrally modulated according to a first spectral map, and image 136 is spectrally modulated according to a second spectral map, where the first spectral map is spectrally complementary to the second spectral map. According to a preferred embodiment of the present invention the first and second spectral maps are compatible with the spectral maps characterizing the optical relay device, so as to allow image 134 to successfully arrive at the left eye and image 136 to successfully arrive at the right eye. More specifically, the first spectral map is selected such that at least a few light rays of image 134 (which typically constitute off-central regions of the image), are diffracted by input grating 13, propagate in substrate 14 via total internal reflection and impinge on left output grating 15 but not on right output grating 19. Similarly, the second spectral map is selected such that at least a few light rays of image 136 are diffracted by grating 13, propagate in substrate 14 via total internal reflection and impinge on grating 19 but not on grating 15.

A schematic illustration of a spectral map 70 is illustrated in FIG. 3. Spectral map 70 preferably represents, for each location (x, y) on the image (as constituted by the collimated light while impinging on input grating 13), a sub-spectrum Δλ(x, y) according to which the color content of location (x, y) is limited. Typically, but not obligatorily, the spectral map is substantially uniform across the transverse direction (x direction in the present coordinate system) and non-uniform along the longitudinal or parallax direction (y direction in the present coordinate system). Hence, the sub-spectrum Δλ typically varies with one spatial coordinate.

In the simplified illustration of FIG. 3, spectral map 70 is shown as having three regions: a left region 72, a center portion 73 and a right region 74, each being characterized by a different sub-spectrum. It is to be understood, however, that more involved spectral maps are not excluded from the scope of the present invention. For example, the spectral maps can be characterized by a discrete or continues color gradient across the parallax direction or any other direction of the respective image. The color gradient can be constant or it can vary across the image. A spectral map having three regions each having a different sub-spectrum is to be understood as a special case of a discrete color gradient, while a spectral map having two regions, such as that in which region 73 has a zero width, is another special case of a discrete color gradient.

According to a preferred embodiment of the present invention the first spectral map is selected so as to ensure that the left part of image 134 is limited in color content to wavelengths λ satisfying λ>λ_{L}, and the right part of image 134 is limited in color content to wavelengths satisfying λ<λ_{H}, where λ_{L} and λ_{H} are predetermined wavelength thresholds, and λ_{L}≦λ_{H}. Conversely, the second spectral map is preferably selected so as to ensure that the left part of image 136 is limited in color content to wavelengths satisfying λ<λ_{H} and the right part of image 136 is limited in color content to wavelengths satisfying λ>λ_{L}. Without loss of generality, the locations (x, y) on the image can be defined such that the right half of the image is characterized by positive longitudinal coordinates and the left half of the image is characterized by negative longitudinal coordinates. In this representation, the right part of the image comprises all picture-elements of the image having a positive longitudinal coordinate which is larger than a positive spatial threshold y₁, and the left part of the image comprises all picture-elements having a negative longitudinal coordinate which is lower than a negative spatial threshold −y₂. Mathematically, the left part of the image is characterized by (x, y>y₁) and the left part of the image is characterized by (x, y<−y₂). For example, the right part of the image can include the rightmost third and the left part of the image can include the leftmost third of the image.

In a preferred embodiment the second spectral map is a mirror image of the first spectral map in the longitudinal dimension, such that Δλ₁(x, y)=Δλ₂(x, −y), where the subscripts 1 and 2 denote the first and the second spectral maps respectively, and (x, y)=(0, 0) is the center of image 34 in both the transverse and the longitudinal dimensions.

Consider, for example, a simple embodiment in which, map 70 includes a left region 72 characterized by a sub-spectrum Δλ_{B} which includes the lower two thirds of the visible light spectrum (say, from blue to green), a right region 74 characterized by a sub-spectrum Δλ_{R} which includes the upper two thirds of the visible light spectrum (say, from green to red), and a center region 73 which includes substantially the entire visible light spectrum Δλ_{ALL} (say, from blue to red). In this embodiment, map 70 can be used for modulating the right-eye image 136 to allow its left, bluish, part as well as its right, reddish, part to impinge on right output grating 19. At the same time, light rays originated from off-central regions 78 (see FIG. 2a) of the right-eye image 136 which are characterized by sufficiently large (in absolute value) impinging angles, do not impinge on left output grating 15, either because the total internal reflection condition is not met or because the diffraction angles, hence the corresponding hop length, of such light rays is too large for any impingement on grating 15.

The spectral map of left-eye image 134 preferably complements the spectral map of the right-eye image 136. In the present example, the left region of the map is characterized by sub-spectrum Δλ_{R} (say, from green to red), and the right region of the map is characterized by Δλ_{B} (say, from blue to green). As will be appreciated by one ordinarily skilled in the art, the modulation of the left-eye image according to such spectral map ensures that light rays originated from the left, reddish, part as well as the right, bluish, part of image 134 impinge on left output grating 15, and that light rays originated from off-central regions of image 134 do not impinge on grating 19.

Thus, system 100 provides different optical information to the left eye and the right eye of the viewer. Since images 134 and 136 are parallactically related, the viewer of stereoscopic image 34 perceives a structure such as depth, thickness or the like and image 34 appears three-dimensional, as if it was an anaglyph viewed through mutually exclusive filters.

Image 134 is preferably superimposed onto image 136 in a manner such that central regions of image 134 are spatially interlaced with central regions of image 136, to form an interlaced image region 76, which can be modulated according to spectral map region 73. The spatially interlacing can be according to any known scheme, including, without limitation, row-wise interlacing, column-wise interlacing, pixel-wise interlacing and random interlacing.

Region 76 typically corresponds to the overlap between first 26 and second 32 partial fields-of-view as illustrated in FIG. 2c. Thus, light rays originating from region 76 are diffracted by input grating 13, bifurcate (negative and positive diffraction orders), propagate in substrate 14 via total internal reflection and impinge on both output grating. Since, as stated, the off-central regions of image 134 exclusively arrive to the left-eye and the off-central region of image 136 exclusively arrives to the right-eye, the human visual system can infer stereoscopic image 34 even though the optical information in region 76 is entangled. In various exemplary embodiments of the invention the spectral maps are selected so as to minimize the area of region 76. According to a preferred embodiment of the present invention region 76 includes less than X % of the image area, where X is preferably about 70, more preferably about 50, more preferably about 25, even more preferably about 10.

Image generating system 121 can be either analog or digital. An analog image generating system typically comprises a light source 127, at least one image carrier 29 and a collimator 44. Collimator 44 serves for collimating the input light, if it is not already collimated, prior to impinging on substrate 14. In the schematic illustration of FIG. 2a, collimator 44 is illustrated as integrated within system 121, however, this need not necessarily be the case since, for some applications, it may be desired to have collimator 44 as a separate element. Thus, system 121 can be formed of two or more separate units. For example, one unit can comprise the light source and the image carrier, and the other unit can comprise the collimator. Collimator 44 is positioned on the light path between the image carrier and the input grating of device 10.

Any collimating element known in the art may be used as collimator 44, for example a converging lens (spherical or non spherical), an arrangement of lenses, a diffractive optical element and the like. The purpose of the collimating procedure is for improving the imaging ability.

In case of a converging lens, a light ray going through a typical converging lens that is normal to the lens and passes through its center, defines the optical axis. The bundle of rays passing through the lens cluster about this axis and may be well imaged by the lens, for example, if the source of the light is located as the focal plane of the lens, the image constituted by the light is projected to infinity.

Other collimating means, e.g., a diffractive optical element, may also provide imaging functionality, although for such means the optical axis is not well defined. The advantage of a converging lens is due to its symmetry about the optical axis, whereas the advantage of a diffractive optical element is due to its compactness.

Representative examples for light source 127 include, without limitation, a lamp (incandescent or fluorescent), one or more LEDs or OLEDs, and the like.

Representative examples for image carrier 29 include, without limitation, a miniature slide, a reflective or transparent microfilm and a hologram. The light source can be positioned either in front of the image carrier (to allow reflection of light therefrom) or behind the image carrier (to allow transmission of light therethrough). Optionally and preferably, system 121 comprises a miniature CRT. Miniature CRTs are known in the art and are commercially available, for example, from Kaiser Electronics, a Rockwell Collins business, of San Jose, Calif.

When a digital image generating system is employed, image carrier 29 typically comprises at least one display. The use of certain displays may require, in addition, the use of a light source and/or a collimator. In the embodiments in which system 121 is formed of two or more separate units, one unit can comprise the display and light source, and the other unit can comprise the collimator.

Light sources suitable for a digital image generating system include, without limitation, a lamp (incandescent or fluorescent), one or more LEDs (e.g., red, green and blue LEDs) or OLEDs, and the like. Suitable displays include, without limitation, rear-illuminated transmissive or front-illuminated reflective LCD, OLED arrays, Digital Light Processing™ (DLP™) units, miniature plasma display, and the like. A positive display, such as OLED or miniature plasma display, may not require the use of additional light source for illumination. Transparent miniature LCDs are commercially available, for example, from Kopin Corporation, Taunton, Mass. Reflective LCDs are are commercially available, for example, from Brillian Corporation, Tempe, Ariz. Miniature OLED arrays are commercially available, for example, from eMagin Corporation, Hopewell Junction, N.Y. DLP™ units are commercially available, for example, from Texas Instruments DLP™ Products, Plano, Tex. The pixel resolution of the digital miniature displays varies from QVGA (320×240 pixels) or smaller, to WQUXGA (3840×2400 pixels).

System 100 is particularly useful for providing a stereoscopic image in devices having relatively small screens. For example, cellular phones and personal digital assistants (PDAs) are known to have rather small on-board displays. PDAs are also known as Pocket PC, such as the trade name iPAQ™ manufactured by Hewlett-Packard Company, Palo Alto, Calif. The above devices, although capable of storing and downloading a substantial amount of information in a form of single frames or moving images, fail to provide the user with sufficient field-of-view due to their small size displays.

Thus, according to a preferred embodiment of the present invention system 100 comprises a data source 125 which can communicate with system 121 via a data source interface 123. Any type of communication can be established between interface 123 and data source 125, including, without limitation, wired communication, wireless communication, optical communication or any combination thereof. Interface 123 is preferably configured to receive a stream of imagery data (e.g., video, graphics, etc.) from data source 125 and to input the data into system 121. Many types or data sources are contemplated. According to a preferred embodiment of the present invention data source 125 is a communication device, such as, but not limited to, a cellular telephone, a personal digital assistant and a portable computer (laptop). Additional examples for data source 125 include, without limitation, television apparatus, portable television device, satellite receiver, video cassette recorder, digital versatile disc (DVD) player, digital moving picture player (e.g., MP4 player), digital camera, video graphic array (VGA) card, and many medical imaging apparatus, e.g., ultrasound imaging apparatus, digital X-ray apparatus (e.g., for computed tomography) and magnetic resonance imaging apparatus.

In addition to the imagery information, data source 125 may generate also audio information. The audio information can be received by interface 123 and provided to the user, using an audio unit 31 (speaker, one or more earphones, etc.).

According to various exemplary embodiments of the present invention, data source 125 provides the stream of data in an encoded and/or compressed form. In these embodiments, system 100 further comprises a decoder 133 and/or a decompression unit 135 for decoding and/or decompressing the stream of data to a format which can be recognized by system 121. Decoder 133 and decompression unit 135 can be supplied as two separate units or an integrated unit as desired.

System 100 preferably comprises a controller 137 for controlling the functionality of system 121 and, optionally and preferably, the information transfer between data source 125 and system 121. Controller 137 can control any of the display characteristics of system 121, such as, but not limited to, brightness, hue, contrast, pixel resolution and the like. Additionally, controller 137 can transmit signals to data source 125 for controlling its operation. More specifically, controller 137 can activate, deactivate and select the operation mode of data source 125. For example, when data source 125 is a television apparatus or being in communication with a broadcasting station, controller 137 can select the displayed channel; when data source 125 is a DVD or MP4 player, controller 137 can select the track from which the stream of data is read; when audio information is transmitted, controller 137 can control the volume of audio unit 31 and/or data source 125.

The spectral modulation of images 134 and 136 can be achieved in more than one way. In one embodiment, each of images 134 and 136 is captured using a camera which is supplemented by a spectral modulator designed to transmit light in accordance with the respective spectral map. The spectral modulators have each a wavelength dependent transmission across the field-of-view of the camera. The transmissions of the modulators are chosen such that they complement one another. For example, when the spectral map has a left region and a right region, image 134 can be captured using a camera supplemented by a spectral filter which is reddish in its left part and bluish in its right part, and image 136 can be captured using a camera which is supplemented by a spectral filter which is bluish in its left part and reddish in its right part.

In another embodiment, system 100 spectrally modulates the images according to the respective spectral maps. In various exemplary embodiments of the invention the spectral modulation is done electronically, by modulating each individual pixel or group of pixels of the images according to the respective spectral map. For example, system 100 can comprise an image processor 140 configured for performing spectral modulation. In this embodiment, the spectral maps are recorded in a memory medium 142 associated with processor 140. Image processor 140 preferably performs the modulation after the decompression of the image (in the embodiments in which such decompression is employed), but it can also perform the modulation at other levels, at the data source level or after the decoding. Image processor 140 can also be integrated in decoder 133, in which case decoder 133 both ensures that the imagery data are recognized by system 121 and ensures that the left-eye image and the right-eye image are spectrally modulated according to the respective modulation maps.

System 100 can also provide a stereoscopic image using a left-eye image and a right-eye image which are not necessarily limited in their color content. In particular, system 100 can provide a stereoscopic image without any spectral modulation of the left-eye image and the right-eye image.

Thus, according to a preferred embodiment of the present invention image generating system 121 is configured to provide the collimated light such that the left-eye image and the right-eye image are constituted by the light in a temporally alternating manner. In other words, system 121 provides to input grating 13 a sequence of frames in which frames belonging to the left-eye image are temporally interlaced with frames belonging to the right-eye image. In this embodiment, system 100 further comprises an image separating device 80, positioned in front of optical relay device 10 (between device 10 and the eyes of the user) and configured for substantially preventing light constituting left-eye image 134 from arriving at right eye 30, and light constituting right-eye image 136 from arriving at left eye 25. System 100 preferably comprises a single image generating system 121 which provides the two frame sequences to a single input grating. Unlike Song et al. supra, in which the same image reaches each eye of a user at a different time, the system of the present embodiments provides different images to different eyes. Image separating device 80 is preferably synchronized with system 121 in the sense that when system 121 provides a frame of the left-eye image, device 80 allows transmission of the image to the left eye and prevents transmission of the image to the right eye and vice versa. Device 80 preferably comprises a left electronic shutter 82 positioned in front of left output grating 15 and a right electronic shutter 84 positioned in front of right output grating 19.

According to a preferred embodiment of the present invention each eye is provided with a refresh rate of at least 30 Hz, which is the minimal refresh rate commonly required for viewing a motion picture. Thus, according to a preferred embodiment of the present invention electronic shutters 82 and 84 operate at a frequency of at least 30 Hz, more preferably at least 60 Hz, more preferably at least 85 Hz. The refresh rate of the frames provided by system 121 is generally twice the refresh rate provided to each individual eye. Thus, according to a preferred embodiment of the present invention the temporal alternation between the left-eye image and the right-eye image is characterized by a refresh rate of at least 60 Hz, more preferably at least 120 Hz, more preferably at least 170 Hz.

Electronic shutters 82 and 84 can be liquid crystal shutters or electrooptical shutters. Such electronic shutters are known in the art and found in the literature, see, e.g., U.S. Pat. Nos. 4,211,474, 4,729,642, 4,838,657, 4,884,876, 4,967,268, 5,029,987, 5,117,302, 5,308,246, 5,347,383, 5,619,266, 5,877,825, 6,175,350, 6,295,102, 6,413,593, 6,436,312, 6,603,522, 6,674,493, 6,687,399, 6,791,599, 6,804,029, 6,833,887, 6,943,852, 7,002,643. Electrooptical shutters are preferred when the light coming out of the output gratings is polarized. In this case, the electrooptical shutters are combined with a left polarization analyzer 86 and a right polarization analyzer 88. In response to bias voltage, the electrooptical shutter rotates the polarization of the light to a polarization direction which is substantially orthogonal to the polarization direction of the polarization analyzer. Thus, upon application of bias voltage, light is not transmitted through the analyzer. When the voltage bias is removed, the polarization of the light is restored and transmission through the analyzer is allowed.

In any of the above embodiments, system 100 or a portion thereof (e.g., device 10) can be integrated with a wearable device, such as, but not limited to, a helmet or spectacles, to allow the user to view the image, preferably without having to hold optical relay device 10 by hand.

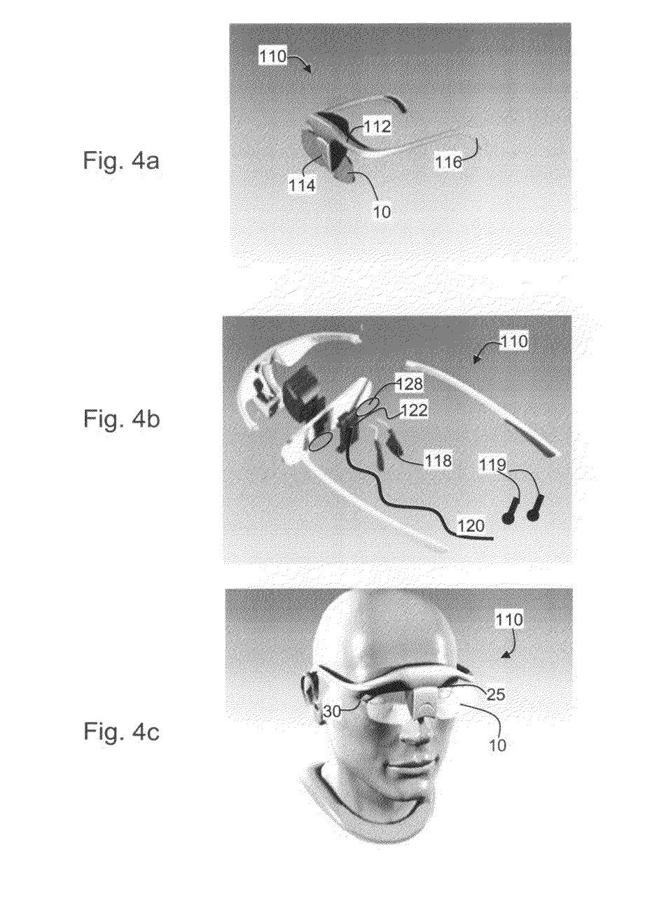

Device 10 can also be used in combination with a vision correction device 128 (not shown, see FIG. 4b), for example, one or more corrective lenses for correcting, e.g., short-sightedness (myopia). In this embodiment, the vision correction device is preferably positioned between the eyes and device 10. According to a preferred embodiment of the present invention system 100 further comprises correction device 128, integrated with or mounted on device 10.

Alternatively system 100 or a portion thereof can be adapted to be mounted on an existing wearable device. For example, in one embodiment device 10 is manufactured as a spectacles clip which can be mounted on the user's spectacles, in another embodiment, device 10 is manufactured as a helmet accessory which can be mounted on a helmet's screen.

Reference is now made to FIGS. 4a-c which illustrate a wearable device 110 in a preferred embodiment in which spectacles are used. According to the presently preferred embodiment of the invention device 110 comprises a spectacles body 112, having a housing 114, for holding image generating system 121 (not shown, see FIG. 2a); a bridge 122 having a pair of nose clips 118, adapted to engage the user's nose; and rearward extending arms 116 adapted to engage the user's ears. Optical relay device 10 is preferably mounted between housing 114 and bridge 122, such that when the user wears device 110, element 19 is placed in front of first eye 30, and element 15 is placed in front of second eye 25. According to a preferred embodiment of the present invention device 110 comprises a one or more earphones 119 which can be supplied as separate units or be integrated with arms 116.

Interface 123 (not explicitly shown in FIGS. 4a-c) can be located in housing 114 or any other part of body 112. In embodiments in which decoder 133 is employed, decoder 133 can be mounted on body 112 or supplied as a separate unit as desired. Communication between data source 125 and interface 123 can be, as stated, wireless, in which case no physical connection is required between wearable device 110 and data source 125. In embodiments in which the communication is not wireless, suitable communication wires and/or optical fibers 120 are used to connect interface 123 with data source 125 and the other components of system 100.

The present embodiments can also be provided as add-ons to the data source or any other device capable of transmitting imagery data. Additionally, the present embodiments can also be used as a kit which includes the data source, the image generating system, the binocular device and optionally the wearable device. For example, when the data source is a communication device, the present embodiments can be used as a communication kit.

Following is a description of the principles and operations of optical relay device 10.

Reference is now made to FIGS. 5a-b which are schematic illustrations of wavefront propagation within substrate 14, according to various exemplary embodiments of the present invention. Shown in FIGS. 5a-b are four principal light rays, 51, 52, 53 and 54, respectively emitted from four points, A, B, C and D, of image 34. The illustrations in FIGS. 5a-b lie in the y-z plane. The projections of the incident angles of rays 51, 52, 53 and 54 onto the y-z plane relative to the normal axis are denoted α_{I}⁻⁻, α_{I}⁻⁺, α_{I}⁺⁻ and α_{I}⁺⁺, respectively. As will be appreciated by one of ordinary skill in the art, the first superscript index refer to the position of the respective ray relative to the center of the field-of-view, and the second superscript index refer to the position of the respective ray relative to the normal from which the angle is measured, according to the aforementioned sign convention.

It is to be understood that this sign convention cannot be considered as limiting, and that one ordinarily skilled in the art can easily practice the present invention employing an alternative convention.

Similar notations will be used below for diffraction angles of the rays, with the subscript D replacing the subscript I. Denoting the superscript indices by a pair i, j, an incident angle is denoted generally as α_{I}^{ij}, and a diffraction angle is denoted generally as α_{D}^{ij}, where i j=“−−”, “−+”, “+−”, “+−” or “−−”. The relation between each incident angle, α_{I}^{ij}, and its respective diffraction angle, α_{D}^{ij}, is given by Equation 4, above, with the replacements φ_{iy}→α_{I}^{ij}, and φ_{dy}→═_{D}^{ij}.

Points A and D represent the left end and the right end of image 34, and points B and C are located between points A and D. Thus, rays 51 and 53 are the leftmost and the rightmost light rays of a first asymmetric field-of-view, corresponding to a part A-C of image 34, and rays 52 and 54 are the leftmost and the rightmost light rays of a second asymmetric field-of-view corresponding to a part B-D of image 34. In angular notation, the first and second asymmetric field-of-views are, respectively, [α_{I}⁻⁻, α_{I}⁺⁻] and [α_{I}⁻⁺, α_{I}⁺⁺] (exclusive representations). Note that an overlap field-of-view between the two asymmetric field-of-views is defined between rays 52 and 53, which overlap equals [α_{I}⁻⁺, α_{I}⁺⁻] and corresponds to an overlap B-C between parts A-C and B-D of image 34.

In the configuration shown in FIGS. 5a-b, lens 45 magnifies image 34 and collimates the wavefronts emanating therefrom. For example, principal light rays 51-54 pass through a center of lens 45, impinge on substrate 14 at angles α_{I}^{ij} and diffracted by input grating 13 into substrate 14 at angles α_{D}^{ij}. For the purpose of a better understanding of the illustrations in FIGS. 5a-b, only two of the four diffraction angles (to each side) are shown in each figure, where FIG. 5a shows the diffraction angles to the right of rays 51 and 53 (angles α_{D}⁺⁻ and α_{D}⁻⁻), and FIG. 5b shows the diffraction angles to the right of rays 52 and 54 (angles α_{D}⁻⁺ and α_{D}⁺⁺).

Each diffracted light ray experiences a total internal reflection upon impinging on the inner surfaces of substrate 14 if |α_{D}^{ij}|, the absolute value of the diffraction angle, is larger than the critical angle α_{c}. Light rays with |α_{D}^{ij}|<α_{c} do not experience a total internal reflection hence escape from substrate 14. Generally, because input grating 13 diffracts the light both to the left and to the right, a light ray may, in principle, split into two secondary rays each propagating in an opposite direction within substrate 14, provided the diffraction angle of each of the two secondary rays is larger than α_{c}. To ease the understanding of the illustrations in FIGS. 5a-b, secondary rays diffracting leftward and rightward are designated by a single and double prime, respectively.

Reference is now made to FIG. 5a showing a particular and preferred embodiment in which |α_{D}⁻⁺|=|α_{D}⁺⁻|=α_{c}. Shown in FIG. 5a are rightward propagating rays 51″ and 53″, and leftward propagating rays 52′ and 54′. Hence, in this embodiment, grating 13 split all light rays between ray 51 and ray 52 into two secondary rays, a left secondary ray, impinging on the inner surface of substrate 14 at an angle which is smaller than α_{c}, and a right secondary ray, impinging on the inner surface of substrate 14 at an angle which is larger than α_{c}. Thus, light rays between ray 51 and ray 52 can only propagate rightward within substrate 14. Similarly, light rays between ray 53 and ray 54 can only propagate leftward. On the other hand, light rays between rays 52 and 53, corresponding to the overlap between the asymmetric field-of-views, propagate in both directions, because grating 13 split each such ray into two secondary rays, both impinging the inner surface of substrate 14 at an angle larger than the critical angle, a_{c}.

Thus, light rays of the asymmetrical field-of-view defined between rays 51 and 53 propagate within substrate 14 to thereby reach second output grating 19 (not shown in FIG. 5a), and light rays of the asymmetrical field-of-view defined between rays 52 and 54 propagate within substrate 14 to thereby reach left output grating 15 (not shown in FIG. 5a).

In another embodiment, illustrated in FIG. 5b, the light rays at the largest entry angle split into two secondary rays, both with a diffraction angle which is larger than α_{c}, hence do not escape from substrate 14. However, whereas one secondary ray experience a few reflections within substrate 14, and thus successfully reaches its respective output grating (not shown), the diffraction angle of the other secondary ray is too large for the secondary ray to impinge the other side of substrate 14, so as to properly propagate therein and reach its respective output grating.

Specifically shown in FIG. 5b are original rays 51, 52, 53 and 54 and secondary rays 51′, 52″, 53′ and 54″. Ray 54 splits into two secondary rays, ray 54′ (not shown) and ray 54″ diffracting leftward and rightward, respectively. However, whereas rightward propagating ray 54″ diffracted at an angle α_{D}⁺⁺ experiences a few reflection within substrate 14 (see FIG. 5b), leftward propagating ray 54′ either diffracts at an angle which is too large to successfully reach grating 15, or evanesces.

Similarly, ray 52 splits into two secondary rays, 52′ (not shown) and 52″ diffracting leftward and rightward, respectively. For example, rightward propagating ray 52″ diffracts at an angle α_{D}⁻⁺>α_{c}. Both secondary rays diffract at an angle which is larger than α_{c}, experience one or a few reflections within substrate 14 and reach output grating 15 and 19 respectively (not shown). In the case that α_{D}⁻⁺ is the largest angle for which the diffracted light ray will successfully reach the output grating 19, all light rays emitted from part A-B of the image do not reach grating 19 and all light rays emitted from part B-D successfully reach grating 19. Similarly, if angle α_{D}⁺⁻ is the largest angle (in absolute value) for which the diffracted light ray will successfully reach output grating 15, then all light rays emitted from part C-D of the image do not reach grating 15 and all light rays emitted from part A-C successfully reach grating 15.

Thus, light rays of the asymmetrical field-of-view defined between rays 51 and 53 propagate within substrate 14 to thereby reach output grating 15, and light rays of the asymmetrical field-of-view defined between rays 52 and 54 propagate within substrate 14 to thereby reach output grating 19.

Any of the above embodiments can be successfully implemented by a judicious design of the optical relay device, and, more specifically the input/output gratings and the substrate.

In a preferred embodiment in which surfaces 23 and 24 of substrate 14 are substantially parallel, gratings 13 and 15 can be designed, for a given spectrum, solely based on the value of the anticlockwise field-of-view angle θ⁻ and the value of the shortest wavelength λ_{B}. For example, when linear gratings are employed, the period, D, of the gratings can be selected based on θ⁻ and λ_{B}, irrespectively of the optical properties of substrate 14 or any wavelength longer than λ_{B}.

According to a preferred embodiment of the present invention D is selected such that the ratio λ_{B}/D is from about 1 to about 2. A preferred expression for D is given by the following equation:

D=λ_{B}/[n_{A}(1−sin θ⁻)]. (EQ. 6)

It is appreciated that D, as given by Equation 6, is a maximal grating period. Hence, in order to accomplish total internal reflection D can also be smaller than λ_{B}/[n_{A}(1−sin θ⁻)].

Substrate 14 is preferably selected such as to allow light having any wavelength within the spectrum and any striking angle within the field-of-view to propagate in substrate 14 via total internal reflection.

According to a preferred embodiment of the present invention the refraction index of substrate 14 is larger than λ_{R}/D+n_{A} sin(θ⁺). More preferably, the refraction index, n_{S}, of substrate 14 satisfies the following equation:

n_{S}≧[λ_{R}/D+n_{A} sin(θ⁺)]/sin(α_{D}^{MAX}). (EQ. 7)

where α_{D}^{MAX} is the largest diffraction angle, e.g., the diffraction angle of the light ray 17. There are no theoretical limitations on α_{D}^{MAX}, except from a requirement that it is positive and smaller than 90 degrees. α_{D}^{MAX} can therefore have any positive value smaller than 90°. Various considerations for the value α_{D}^{MAX} are found in U.S. Pat. No. 6,757,105, the contents of which are hereby incorporated by reference.

The thickness, t, of substrate 14 is preferably from about 0.1 mm to about 5 mm, more preferably from about 1 mm to about 3 mm, even more preferably from about 1 to about 2.5 mm. For multicolor use, t is preferably selected to allow simultaneous propagation of plurality of wavelengths, e.g., t>10 λ_{R}. The dimensions of substrate 14 are preferably from about 70 mm to about 160 mm in length and from about 10 mm to about 30 mm in width. The typical dimensions of the diffractive gratings depend on the application for which device 10 is used. For example, device 10 can be employed in a near eye display, such as the display described in U.S. Pat. No. 5,966,223, in which case the typical dimensions of the input grating are from about 5 mm to about 15 mm in length and from about 10 mm to about 30 mm in width, and the typical dimensions of each output grating are from about 12 mm to about 30 mm in length and from about 8 mm to about 27 mm in width. The contents of U.S. Patent Application No. 60/716,533 and International patent application No. PCT/IL2006/001050, which provide details as to the design of the diffractive gratings and the selection of their dimensions, are hereby incorporated by reference.

For different viewing applications, such as the application described in U.S. Pat. No. 6,833,955, the contents of which are hereby incorporated by reference, the length of substrate 14 can be 1000 mm or more, and the length of diffractive grating 15 can have a similar size. When the length of the substrate is longer than 100 mm, then t is preferably larger than 2 millimeters. This embodiment is advantageous because it reduces the number of hops and maintains the substrate within reasonable structural/mechanical conditions.

Device 10 is capable of transmitting light having a spectrum spanning over at least 100 nm. More specifically, the shortest wavelength, λ_{B}, generally corresponds to a blue light having a typical wavelength of between about 400 to about 500 nm and the longest wavelength, λ_{R}, generally corresponds to a red light having a typical wavelength of between about 600 to about 700 nm.

According to a preferred embodiment of the present invention the period, D, of the gratings and/or the refraction index, nₛ, of the substrate are selected so to provide the two asymmetrical field-of-views, while ensuring a predetermined overlap therebetween. This can be achieved in more than one way.

Hence, in one embodiment, a ratio between the wavelength, λ, of the light and the period D is larger than or equal a unity:

λ/D≧1. (EQ. 8)

This embodiment can be used to provide an optical device operating according to the aforementioned principle in which there is no mixing between light rays of the non-overlapping parts of the field-of-view (see FIG. 5a).

In another embodiment, the ratio λ/D is smaller than the refraction index, n_{S}, of the substrate. More specifically, D and n_{S} can be selected to comply with the following inequality:

D>λ/(nₛp), (EQ. 9)

where p is a predetermined parameter which is smaller than 1.

The value of p is preferably selected so as to ensure operation of the device according to the principle in which some mixing is allowed between light rays of the non-overlapping parts of the field-of-view, as further detailed hereinabove (see FIG. 5b). This can be done for example, by setting p=sin(α_{D}^{MAX}), where (α_{D}^{MAX}) is a maximal diffraction angle. Because there are generally no theoretical limitations on α_{D}^{MAX} (apart from a requirement that its absolute value is smaller than) 90°, it may be selected according to any practical considerations, such as cost, availability or geometrical limitations which may be imposed by a certain miniaturization necessity. Hence, in one embodiment, further referred to herein as the “at least one hop” embodiment, α_{D}^{MAX} is selected so as to allow at least one reflection within a predetermined distance x which may vary from about 30 mm to about 80 mm.

For example, for a glass substrate, with an index of refraction of n_{S}=1.5 and a thickness of 2 mm, a single total internal reflection event of a light having a wavelength of 465 nm within a distance x of 34 mm, corresponds to α_{D}^{MAX}=83.3°.

In another embodiment, further referred to herein as the “flat” embodiment, α_{D}^{MAX} is selected so as to reduce the number of reflection events within the substrate, e.g., by imposing a requirement that all the diffraction angles will be sufficiently small, say, below 80°.

In an additional embodiment, particularly applicable to those situations in the industry in which the refraction index of the substrate is already known (for example when device 10 is intended to operate synchronically with a given device which includes a specific substrate), Equation 10 may be inverted to obtain the value of p hence also the value of α_{D}^{MAX}=sin⁻¹p.

As stated, device 10 can transmit light having a plurality of wavelengths. According to a preferred embodiment of the present invention, for a multicolor image the gratings period is preferably selected to comply with Equation 9, for the shortest wavelength, and with Equation 10, for the longest wavelength. Specifically:

λ_{R}/(nₛp)≦D≦λ_{B}, (EQ. 10)

where λ_{B} and λ_{R} are, respectively, the shortest and longest wavelengths of the multicolor spectrum. Note that it follows from Equation 9 that the index of refraction of the substrate should satisfy, under these conditions, nₛp≧λ_{R}/λ_{B}.

The grating period can also be smaller than the sum λ_{B}+λ_{R}, for example:

$$D = \frac{{λ}_{B} + {λ}_{R}}{{n}_{S} sin ( {α}_{D}^{MAX} ) + {n}_{A}} . \qquad ( EQ . 11 )$$

In any of the above embodiments, output grating 15 is characterized by planar dimensions selected such that at least a portion of one or more outermost light rays within the field-of-view is directed to a two-dimensional region 20 being at a predetermined distance Δz from light transmissive substrate 14. More preferably, the planar dimensions of grating 15 are selected such that the outgoing light beam enters region 20.

To ensure entering of the outermost light ray or the entire outgoing light beam into region 20, the length L_{O} of grating 15 is preferably selected to be larger then a predetermined length threshold, L_{O, min}, and the width W_{O} of grating 15 is preferably selected to be larger then a predetermined width threshold, W_{O, min}. In various exemplary embodiments of the invention the length and width thresholds are given by the following expressions:

L_{O,min}=2Δz tan(Ω_{y}/2)

W_{O,min}=2Δz tan(Ωₓ/2), (EQ. 12)

where Ω_{y} and Ωₓ are the field-of-view of device along the longitudinal and transverse axes of device 10, respectively.

The user may place his or her eye(s) within region 20 to view the virtual image. Thus, in this embodiment, region 20 is the “eye-box” of device 10, and Δz is approximately the distance between the pupil(s) of the user to substrate 14. The distance Δz is referred to herein as the characteristic eye-relief of device 10. For transmitting an image to one eye, the length L_{O} and width W_{O} of grating 15 are preferably about L_{O, min}+Oₚ, and about W_{O, min}+Oₚ, respectively, where Oₚ represents the diameter of the pupil and is typically about 3 millimeters. In various exemplary embodiments of the invention the eye-box is larger than the diameter of the pupil, so as to allow the user to relocate the eye within the eye-box while still viewing the entire virtual image. Thus, denoting the dimensions of region 20 by L_{EB} and W_{EB}, where L_{EB} is measured along the y axis and W_{EB} is measured along the x axis, the length and width of grating 15 are preferably:

L_{O}=L_{O,min}+L_{EB}

W_{O}=W_{O,min}+W_{EB}, (EQ. 13)

where each of L_{EB} and W_{EB} is preferably larger than Oₚ, so as to allow the user to relocate the eye within region 20 while still viewing the entire field-of-view.

The dimensions of input grating 13 are preferably selected to allow all light rays within the field-of-view to propagate in substrate 14 such as to impinge on the area of grating 15. In various exemplary embodiments of the invention the length L_{I} of input grating 13 equals from about X to about 3X where X is preferably a unit hop-length characterizing the propagation of light rays within substrate 14. Typically, X equals the hop-length of the light-ray with the minimal hop-length, which is one of the outermost light-rays in the field-of-view (ray 18 in the exemplified illustration of FIG. 2b). When the light has a plurality of wavelengths, X is typically the hop-length of one of the outermost light-rays which has the shortest wavelength of the spectrum.

According to a preferred embodiment of the present invention the width W_{O} of grating 15 is smaller than the width W_{I} of grating 13. W_{I} is preferably calculated based on the relative arrangement of gratings 13 and 15. For example, the relation between W_{I} and W_{O} can be calculated preferably using the following equation:

W_{I}=2(L_{O}+Δy)tan γ+W_{O}, (EQ. 14)

where Δy is the lateral separation between grating 13 and grating 15 along the longitudinal axis of device 10 and γ is a predetermined angular parameter. A typical value for the absolute value of γ is, without limitation, from about 6° to about 15°. Various considerations for selecting the value of y are provided in International Patent Application Nos. PCT/IL2006/001050 and PCT/IL2006/001051, assigned to the common assignee of the present invention and fully incorporated herein by reference.

Thus, a viewer placing his or her eye in region 20 of dimensions L_{EB}×W_{EB}, receives at least a portion of any light ray within the field-of-view, provided the distance between the eye and grating 15 equals Δz or is smaller than Δz.

The preferred value for Δz is, without limitation, from about 15 millimeters to about 35 millimeters, the preferred value for Δy is, without limitation, from a few millimeters to a few centimeters, the preferred value for L_{EB} is, without limitation, from about 5 millimeters to about 13 millimeters, and the preferred value for W_{EB} is, without limitation, is from about 4 millimeters to about 9 millimeters. For a given field-of-view, selection of large Δz results in smaller eye-box dimensions L_{EB} and W_{EB}, as known in the art. Conversely, small Δz allows for larger eye-box dimensions L_{EB} and W_{EB}.

L_{O, min} and W_{O, min} are preferably calculated using Equation 12, and together with the selected dimensions of region 20 (L_{EB} and W_{EB}), the dimensions of grating 15 (L_{O} and W_{O}) can be calculated using Equation 13.

Once L_{O} and W_{O} are calculated, the transverse dimension W_{I} of input grating 13 is preferably calculated by selecting values for Δy and γ and using Equation 14. The longitudinal dimension L_{I} is generally selected from about 3 millimeters and about 15 millimeters.

In various exemplary embodiments of the invention, the gratings of the optical relay device are designed to transmit an image covering a wide field-of-view to both eyes of the user for any interpupillary distance from a minimal value denoted IPDₘᵢₙ to a maximal value denoted IPDₘₐₓ.

In this embodiment, the planar dimensions of gratings 15 and 19 are selected such that eyes 25 and 30 are respectively provided with partial field-of-views 26 and 32 for any interpupillary distance IPD satisfying IPDₘᵢₙ≦IPD≦IPDₘₐₓ. This is preferably ensured by selecting the lengths L_{EB} of regions 20 and 22 according to the following weak inequality:

L_{EB}≧(IPDₘᵢₙ−IPDₘᵢₙ)/2. (EQ. 15)

Once L_{EB} is selected to satisfy Equation 15, the lengths and widths of output gratings 15 and 19 can be set according to Equations 13 substantially as described hereinabove. According to a preferred embodiment of the present invention the longitudinal center of each of gratings 15 and 19 is located at a distance of (IPDₘₐₓ+IPDₘᵢₙ)/4 from the longitudinal center of grating 13.

The width W_{I} of grating 13 is preferably larger than the width of each of gratings 15 and 19. The calculation of W_{I} is preferably, but not obligatorily, performed using a procedure similar to the procedure described above, see Equation 14. When it is desired to manufacture a symmetric optical relay, the same planar dimensions L_{O}×W_{O} are used for both output gratings 15 and 19, and the same lateral separation Δy is used between gratings 13 and 15 and between gratings 13 and 19. In this case, the width W_{I} of the input grating can be set according to Equation 14 using the angular parameter γ as described above. Equation 14 can also be used for configuration in which the lateral separation between gratings 13 and 15 differs from the lateral separation between gratings 13 and 19. In this case the value of Δy which is used in the calculation is preferably set to the larger of the two lateral separations.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. An optical system for transmitting a stereoscopic image to a right eye and a left eye of a user, comprising:
(a) an optical relay device, having a light-transmissive substrate, an input grating, a left output grating and a right output grating, said optical relay device being designed and constructed such that light is diffracted by said input grating, propagates within said light-transmissive substrate via total internal reflection, and diffracted out of said light-transmissive substrate by at least one of said left and right output gratings; and
(b) an image generating system, optically coupled to said input grating and configured for providing collimated light constituting a left-eye image, spectrally modulated according to a first spectral map, and a right-eye image, spectrally modulated according to a second spectral map, wherein said left-eye image is parallactically related to said right-eye image, and said first spectral map is spectrally complementary to said second spectral map;
wherein said first spectral map is selected such that at least a few light rays of said left-eye image are diffracted by said input grating, propagate in said light transmissive substrate via total internal reflection and impinge on said left output grating but not on said right output grating, and said second spectral map is selected such that at least a few light rays of said right-eye image are diffracted by said input grating, propagate in said light transmissive substrate via total internal reflection and impinge on said right output grating but not on said left output grating.

2. A method of transmitting a stereoscopic image to a right eye and a left eye of a user, comprising:
(a) providing collimated light constituting a left-eye image, spectrally modulated according to a first spectral map, and a right-eye image, spectrally modulated according to a second spectral map, wherein said left-eye image is parallactically related to said right-eye image, and said first spectral map is spectrally complementary to said second spectral map;
(b) using an input grating for diffracting said collimated light in a manner such that said light propagates within a light-transmissive substrate via total internal reflection;
(c) using a left output grating for diffracting light rays of said left-eye image out of said light-transmissive substrate; and
(d) using a right output grating for diffracting light rays of said right-eye image out of said light-transmissive substrate;
wherein said first spectral map is selected such that at least a few light rays of said left-eye image impinge on said left output grating but not on said right output grating, and said second spectral map is selected such that at least a few light rays of said right-eye image impinge on said right output grating but not on said left output grating.

3. The system of claim 1, wherein said few light rays of said left-eye image constitute off-central regions of said left-eye image, and said few light rays of said right-eye image constitute off-central regions of said right-eye image.

4. The system of claim 1, wherein said left-eye image is superimposed onto said right-eye image such that central regions of said left-eye image are spatially interlaced with central regions of said right-eye image, thereby forming an interlaced image region.

5. The system of claim 4, wherein each of said first spectral map and said second spectral map is selected so as to minimize said interlaced image region.

6. The system of claim 4, wherein each of said first spectral map and said second spectral map is selected such that light rays constituting said interlaced image region are diffracted by said input grating, propagate in said light transmissive substrate via total internal reflection and impinge on said left and said right output gratings.

7. The system of claim 1, wherein each of said first spectral map and said second spectral map is characterized by a color gradient across the respective image.

8. The system of claim 1, wherein said first spectral map is selected so as to ensure that a left part of said left-eye image is limited in color content to wavelengths higher than a first predetermined threshold, and a right part of said left-eye image is limited in color content to wavelengths lower than a second predetermined threshold.

9. The system of claim 8, wherein said first predetermined threshold substantially equals said second predetermined threshold.

10. The system of claim 8, wherein said first predetermined threshold is lower than said second predetermined threshold.

11. The system of claim 1, wherein said second spectral map is selected so as to ensure that a right part of said right-eye image is limited in color content to wavelengths higher than a first predetermined threshold, and a left part of said right-eye image is limited in color content to wavelengths lower than a second predetermined threshold.

12. The system of claim 11, wherein said first predetermined threshold substantially equals said second predetermined threshold.

13. The system of claim 11, wherein said first predetermined threshold is lower than said second predetermined threshold.

14. The system of claim 1, further comprising an image processor configured for spectrally modulating said left-eye image according to said first spectral map and said right-eye image according to said second spectral map.

15. The system of claim 14, further comprising a memory medium associated with said image processor and configured for storing said first spectral map and said second spectral map.

16. The method of claim 2, wherein said providing said collimated light comprises spectrally modulating said left-eye image according to said first spectral map, and spectrally modulating said right-eye image according to said second spectral map.

17. A binocular device for transmitting a stereoscopic image to a right eye and a left eye of a user, the binocular device being optically coupleable to an image generating system configured for providing collimated light constituting, in a temporally alternating manner, a left-eye image and a right-eye image having a parallactic relation thereamongst, the binocular device comprising:
an optical relay device, having a light-transmissive substrate, an input grating, a left output grating and a right output grating, said optical relay device having a front and a back, and being designed and constructed such that light is diffracted by said input grating, propagates within said light-transmissive substrate via total internal reflection, and diffracted out of said light-transmissive substrate by at least one of said left and right output gratings; and
an image separating device positioned in front of said optical relay device and configured for substantially preventing light constituting said left-eye image from arriving at the right eye, and light constituting said right-eye image from arriving at the left eye, thereby to separate said left-eye image from said right-eye image.

18. An optical system for transmitting a stereoscopic image to a right eye and a left eye of a user, comprising:
an image generating system configured for providing collimated light constituting, in a temporally alternating manner, a left-eye image and a right-eye image having a parallactic relation thereamongst;
an optical relay device, having a light-transmissive substrate, an input grating, a left output grating and a right output grating, said optical relay device having a front and a back, and being designed and constructed such that light is diffracted by said input grating, propagates within said light-transmissive substrate via total internal reflection, and diffracted out of said light-transmissive substrate by at least one of said left and right output gratings; and
an image separating device positioned in front of said optical relay device and configured for substantially preventing light constituting said left-eye image from arriving at the right eye, and light constituting said right-eye image from arriving at the left eye, thereby to separate said left-eye image from said right-eye image.

19. The system of claim 18, wherein said input grating is a single grating and said image generating system is optically coupled to said input grating such that both said left-eye image and said right-eye image are diffracted by said input grating.

20. The device of claim 17, wherein said image separating device comprises a left electronic shutter positioned in front of said left output grating and a right electronic shutter positioned in front of said right output grating, said left and said right electronic shutters being synchronized with said image generating system.

21. The device of claim 20, wherein said left and said right electronic shutters are liquid crystal shutters.

22. The device of claim 20, wherein said left and said right electronic shutters are electrooptical shutters and said image separating device further comprises a left polarization analyzer positioned in front of said left electronic shutter, and a right polarization analyzer positioned in front of said right electronic shutter.

23. The system of claim 1, wherein said input grating is designed and constructed such that:
light rays impinging on said input grating at an angle within a first partial field-of-view and having wavelengths within a first sub-spectrum are diffracted by said input grating, propagate via total internal reflection, and impinge on said left output grating but not on said right output grating; and
light rays impinging on said input grating at an angle within said first partial field-of-view and having wavelengths within a second sub-spectrum are diffracted by said input grating, propagate via total internal reflection, and impinge on said right output grating but not on said left output grating.

24. The system of claim 23, wherein said input grating is further designed and constructed such that:
light rays impinging on said input grating at an angle within a second partial field-of-view and having wavelengths within said first sub-spectrum are diffracted by said input grating, propagate via total internal reflection, and impinge on said right output grating but not on said left output grating; and
light rays impinging on said input grating at an angle within said second partial field-of-view and having wavelengths within said second sub-spectrum are diffracted by said input grating, propagate via total internal reflection, and impinge on said left output grating but not on said right output grating.

25. The system of claim 24, wherein said first partial field-of-view is from a first clockwise angle to a first anticlockwise angle, said second partial field-of-view is from a second clockwise angle to a second anticlockwise angle, said first sub-spectrum is characterized by wavelengths below a first threshold, and said second sub-spectrum is characterized by wavelengths above a second threshold.

26. The system of claim 1, wherein said image generating system comprises a light source, at least one image carrier and a collimator for collimating light produced by said light source and reflected or transmitted through said at least one image carrier.

27. The system of claim 1, wherein said image generating system comprises at least one miniature display and a collimator for collimating light produced by said at least one miniature display.

28. The system of claim 1, wherein said image generating system comprises a light source, configured to produce light modulated by imagery data, and a scanning device for scanning said light modulated imagery data onto the optical relay device.
